(19) United States
(12) Patent Application Publication
(10) Pub. No.: US 2005/0212842 A1
(43) Pub. Date: Sep. 29, 2005

(54) Apparatus for and method of detecting a printed state

(75) Inventor: Ikuo Katsumata, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/085,068

(22) Filed: Mar. 22, 2005

(30) Foreign Application Priority Data
Mar. 26, 2004 (JP) 2004-093288

(51) Int. Cl. B41J 29/38

(52) U.S. Cl. 347/14

(57) ABSTRACT

A printed state detecting mark, made up of a printed area and a non-printed area, is printed on an object and illuminated with light. Light, which is reflected from or transmitted through the printed state detecting mark, is detected by a first sensor and a second sensor. A first detected amount of light detected by the first sensor is compared with a predetermined first threshold level to produce a first comparison result, and a second detected amount of light detected by the second sensor is compared with a predetermined second threshold level to produce a second comparison result. A printed state of printed marks on the object is determined based on the first comparison result and the second comparison result.

### BACKGROUND OF THE INVENTION

1. Field of the Invention

The present invention relates to an apparatus and method for detecting the printed state of a mark that has been printed on an object.

2. Description of the Related Art

When a printing device, such as an ink-jet printer or a laser printer, prints a character on an object, if the object is fed improperly or the print head suffers from an irregularity, then the character may be printed out of position on the object, or be printed twice, or may not be printed at all, or may be printed in a wrong size on the object.

In order to prevent these various printing failures, which may be caused by an ink shortage or clogging of the print head in an ink-jet printer, for example, it has been known in the art to print a printing failure check mark on an object and to compare a detected signal representative of a light beam reflected from the printing failure check mark with a threshold level, to thereby determine the printed state of the printing failure check mark (see Japanese Laid-Open Patent Publication No. 11-42838).

According to this known technique, however, since only a single printing failure check mark is detected by a single sensor, detection of the printed state of the printing failure check mark merely indicates whether the printing failure check mark has been printed or not. The conventional process does not enable one to identify the actual cause of the printing failure from various printed states.

### SUMMARY OF THE INVENTION

It is a general object of the present invention to provide an apparatus and method for easily detecting the printed state of a mark that has been printed on an object by a printing device.

A major object of the present invention is to provide an apparatus and method for detecting the printed state of a mark that has been printed on an object by a printing device, so as to identify the cause of a printing failure in terms of how the object is fed or how the mark is printed by the printing device.

Another object of the present invention is to provide an apparatus and method for detecting the printed state of a mark that has been printed on an object by a printing device, so as to determine whether or not the mark has been printed out of position on the object.

Still another object of the present invention is to provide an apparatus and method for detecting the printed state of a mark that has been printed on an object by a printing device, so as to determine whether or not the mark has been printed twice on the object.

Yet another object of the present invention is to provide an apparatus and method for detecting the printed state of a mark that has been printed on an object by a printing device, so as to determine whether the mark has actually been printed on the object or not.

Yet still another object of the present invention is to provide an apparatus and method for detecting the printed state of a mark that has been printed on an object by a printing device, so as to determine the size of the mark printed on the object.

According to the present invention, a printed state detecting mark, which is made up of a printed area and a non-printed area, is printed on an object and is detected by a first sensor and a second sensor. A first detected amount of light from the printed area, which is detected by the first sensor, is compared with a predetermined first threshold level to produce a first comparison result. In addition, a second detected amount of light from the non-printed area, which is detected by the second sensor, is compared with a predetermined second threshold level to produce a second comparison result. A printed state of a mark, which has been printed on the object, is determined based on the first comparison result and the second comparison result.

For example, when the printed area is printed in black, if the first detected amount of light from the printed area is greater than the first threshold level, then it may be determined that the printing failure is due to clogging of the print head nozzle, shifting of the printed position, or a reduction in printing size. If the second detected amount of light from the non-printed area is smaller than the second threshold level, then it may be determined that the printing failure is due to shifting of the printed position, a double print blur, or an increase in printing size.

The black printed area may be of any nature, insofar as the amount of light from the printed area is smaller than the amount of light from the non-printed area on the object. For example, the printed area may be formed by coating an object such as corrugated cardboard with an ink which is darker in color than the corrugated cardboard.

When the printed state detecting mark is detected, by means of the first sensor and the second sensor, at a predetermined time after a transported object has been detected, then it can be determined whether the printed mark is positionally shifted in a direction in which the object is fed.

If printed matter and the printed state detecting mark are formed using a single printing means, then a fault of the printing means for forming the printed matter can be detected.

The first sensor and the second sensor may comprise reflective sensors, for detecting amounts of light reflected from the printed area and the non-printed area. The printed state may be determined based on the first and second comparison results, produced by comparing the reflected amounts of light with the first and second threshold levels. Alternatively, the first sensor and the second sensor may comprise transmissive sensors, for detecting amounts of light transmitted through the printed area and the non-printed area. The printed state may be determined based on the first and second comparison results, produced by comparing the transmitted amounts of light with the first and second threshold levels.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a perspective view of a printed state detecting apparatus according to the present invention;

FIG. 2 is a block diagram of the printed state detecting apparatus;

FIG. 3 is a view showing a printed mark and a printed state detecting mark;

FIG. 4 is a flowchart of an operation sequence of the printed state detecting apparatus;

FIG. 5 is a view showing a positional relationship between the printed state detecting mark and first and second reading ranges;

FIG. 6 is a view showing another positional relationship between the printed state detecting mark and the first and second reading ranges;

FIG. 7 is a view showing still another positional relationship between the printed state detecting mark and the first and second reading ranges;

FIG. 8 is a view showing yet another positional relationship between the printed state detecting mark and the first and second reading ranges;

FIG. 9 is a timing chart of a set of signals produced based on a positional relationship between the printed state detecting mark and first and second sensors;

FIG. 10 is a timing chart of a set of signals produced based on another positional relationship between the printed state detecting mark and the first and second sensors;

FIG. 11 is a timing chart of a set of signals produced based on still another positional relationship between the printed state detecting mark and the first and second sensors;

FIG. 12 is a timing chart of a set of signals produced based on yet another positional relationship between the printed state detecting mark and the first and second sensors;

FIG. 13 is a view showing a positional relationship between printed marks and the printed state detecting mark;

FIG. 14 is a view showing another positional relationship between printed marks and the printed state detecting mark; and

FIG. 15 is a view showing still another positional relationship between printed marks and the printed state detecting mark.

### DESCRIPTION OF THE PREFERRED EMBODIMENT

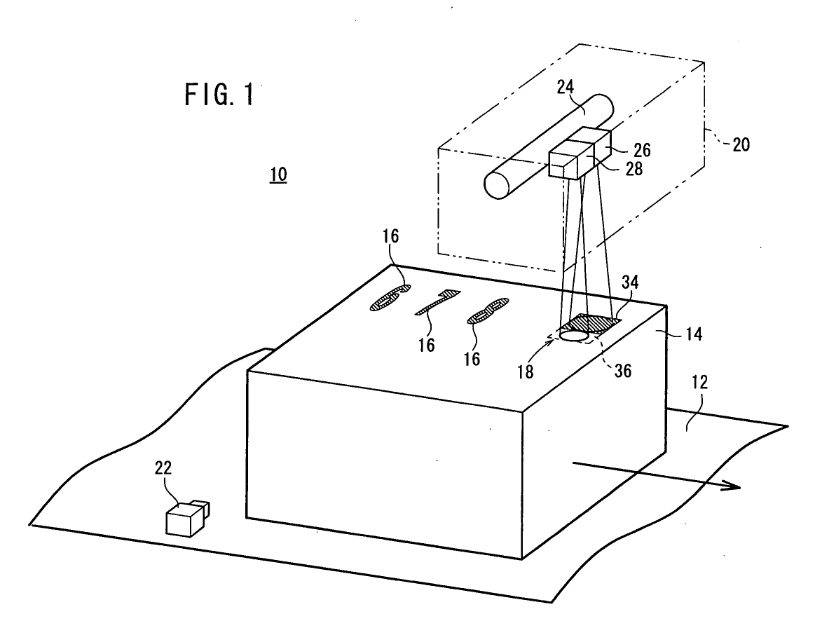

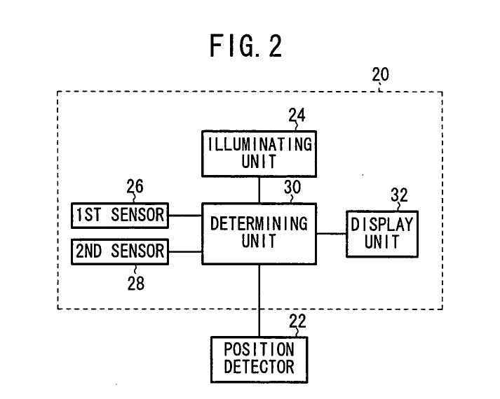

FIG. 1 shows in perspective a printed state detecting apparatus 10 according to the present invention, whereas FIG. 2 shows the printed state detecting apparatus 10 in block form.

As shown in FIG. 1, the printed state detecting apparatus 10 is an apparatus for detecting a printed state detecting mark 18, which is printed together with printed marks 16 on an object 14 that is fed by a feeding device 12, for thereby detecting the printed state of the printed state detecting mark 18. The printed state detecting apparatus 10 has a main block 20 and a position detector 22.

The printed marks 16 and the printed state detecting mark 18 are formed on the object 14 by a single printing device (not shown) such as an ink-jet printer or a laser printer. In the present embodiment, it is assumed that the object 14 comprises a white object, whereas both the printed marks 16 and the printed state detecting mark 18 are printed in black ink or the like.

As shown in FIG. 2, the main block 20 of the printed state detecting apparatus 10 comprises an illuminating unit 24, a first sensor 26, a second sensor 28, a determining unit 30, and a display unit 32.

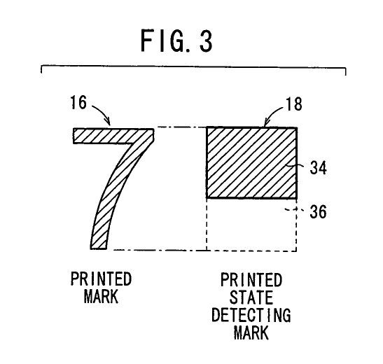

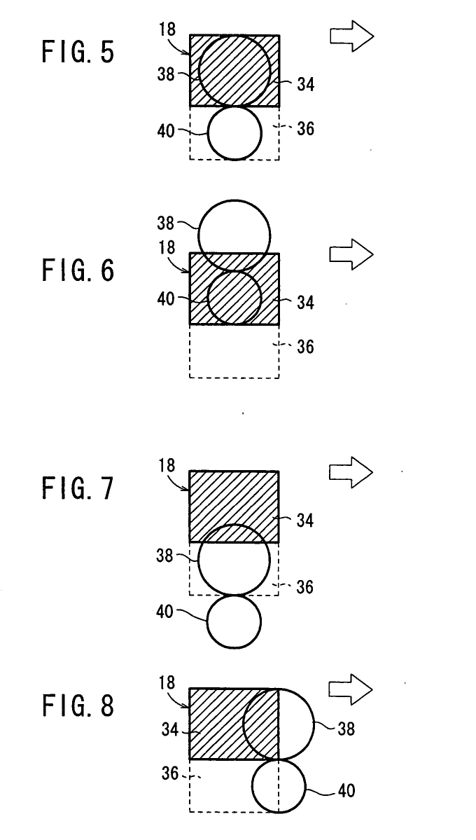

The printed state detecting mark 18 includes a black printed area 34 produced on a surface of the object 14 by the printing device, together with a non-printed area 36 formed by the surface of the object 14 itself (see also FIG. 3). As shown in FIG. 5, when the printing device and the feeding device 12 are operating normally, then the first sensor 26 is set within a first reading range 38 on the printed area 34 and the second sensor 28 is set within a second reading range 40 on the non-printed area 36.

The position detector 22 is a sensor for confirming when the object 14 fed by the feeding device 12 is moved to a position beneath the main block 20.

Each of the first and second sensors 26, 28 comprises a reflective sensor for detecting an amount of light which is reflected from the printed state detecting mark 18 when the detecting mark 18 is illuminated by the illuminating unit 24. Alternatively, each of the first and second sensors 26, 28 may comprise a transmissive sensor. If the first and second sensors 26, 28 comprise transmissive sensors, then the illuminating unit 24 is disposed in a position facing the first and second sensors 26, 28, so that the first and second sensors 26, 28 detect light that is emitted from the illuminating unit 24 and transmitted through the printed state detecting mark 18.

The determining unit 30 serves to control the printed state detecting apparatus 10 in its entirety, and comprises a processor such as a CPU or the like, together with memory devices such as a ROM and a RAM.

The display unit 32 displays information representing a printed state determined by the determining unit 30, and comprises a display device such as an LED, LCD, or the like.

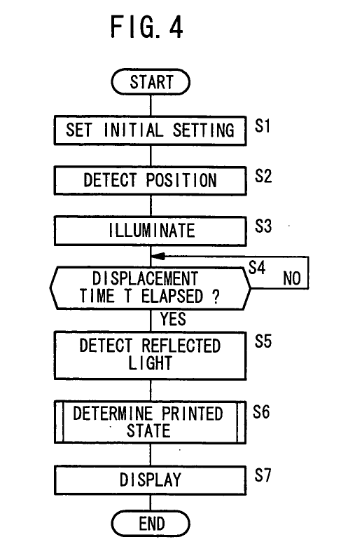

An operation sequence of the printed state detecting apparatus 10 will be described below with reference to FIG. 4.

In step S1, a displacement time T consumed during a normal feed mode when the object 14 is fed by the feeding device 12, after the object 14 is detected by the position detector 22 and until the printed state detecting mark 18 reaches a predetermined position aligned with the first sensor 26 and the second sensor 28, is set as an initial setting in the determining unit 30.

After the initial setting is set in the determining unit 30, the feeding device 12 starts feeding the object 14. In step S2, the position detector 22 detects the object 14 and outputs a detected signal to the determining unit 30.

In step S3, when the detected signal from the position detector 22 is input to the determining unit 30, the determining unit 30 outputs an illumination signal to the illuminating unit 24, which emits illuminating light to illuminate the printed state detecting mark 18.

When the displacement time T has elapsed, after the detected signal from the position detector 22 is input to the determining unit 30 in step S4, then light reflected from the printed state detecting mark 18 that is illuminated by the illuminating unit 24 is detected by the first sensor 26 and the second sensor 28 in step S5. The first sensor 26 and the second sensor 28 output respective detected amounts of reflected light to the determining unit 30.

Specifically, from the amount of light that is applied from the illuminating unit 24 to the printed state detecting mark 18, an amount of light reflected from the printed area 34 is detected by the first sensor 26 and output therefrom as a first detected amount of light to the determining unit 30. Further, the amount of light reflected from the non-printed area 36 is detected by the second sensor 28 and output therefrom as a second detected amount of light to the determining unit 30.

FIG. 5 shows a positional relationship between the printed state detecting mark 18 and the first and second reading ranges 38, 40 when the printed state on the object 14 is normal and the object 14 is fed normally.

As shown in FIG. 5, since the printed area 34 is black, if the first reading range 38 of the first sensor 26 falls within the printed area 34, then the first detected amount of light detected by the first sensor 26 is substantially 0 (zero). Therefore, the first threshold level is preset as a value that is equal or close to 0. When the first detected amount of light is equal to or smaller than the first threshold level, the determining unit 30 outputs an “OFF” detected result (first comparison result).

If the first reading range 38 is not aligned with the printed area 34, or a printing failure has occurred due to the print head nozzle being clogged or the like, the first detected amount of light detected by the first sensor 26 is greater than 0. Thus, when the first detected amount of light is greater than the first threshold level, the determining unit 30 outputs an “ON” detected result (first comparison result).

Since the non-printed area 36 contains no printed material, if the second reading range 40 of the second sensor 28 falls within the non-printed area 36, then the second detected amount of light detected by the second sensor 28 is substantially equal to the amount of illuminating light emitted from the illuminating unit 24. Therefore, the second threshold level is preset as a value that is close to the amount of illuminating light. When the second detected amount of light is equal to or greater than the second threshold level, the determining unit 30 outputs an “ON” detected result (second comparison result).

If the printed area 34 mistakenly falls within the second reading range 40, then the second detected amount of light detected by the second sensor 28 is smaller than the amount of illuminating light. Thus, when the second detected amount of light is smaller than the second threshold level, the determining unit 30 outputs an “OFF” detected result (second comparison result).

It is assumed that the printed marks 16 will not be identical in shape to the printed state detecting mark 18. Further, the area of the first reading range 38 is equal to or smaller than the area of the printed area 34, and the area of the second reading range 40 is equal to or smaller than the area of the non-printed area 36. For increased accuracy when detecting the printed state, the first reading range 38 preferably should have substantially the same shape as the printed area 34.

In step S6, the determining unit 30 determines the printed state on the object 14 based on the first detected amount of light from the first sensor 26 and the second detected amount of light from the second sensor 28.

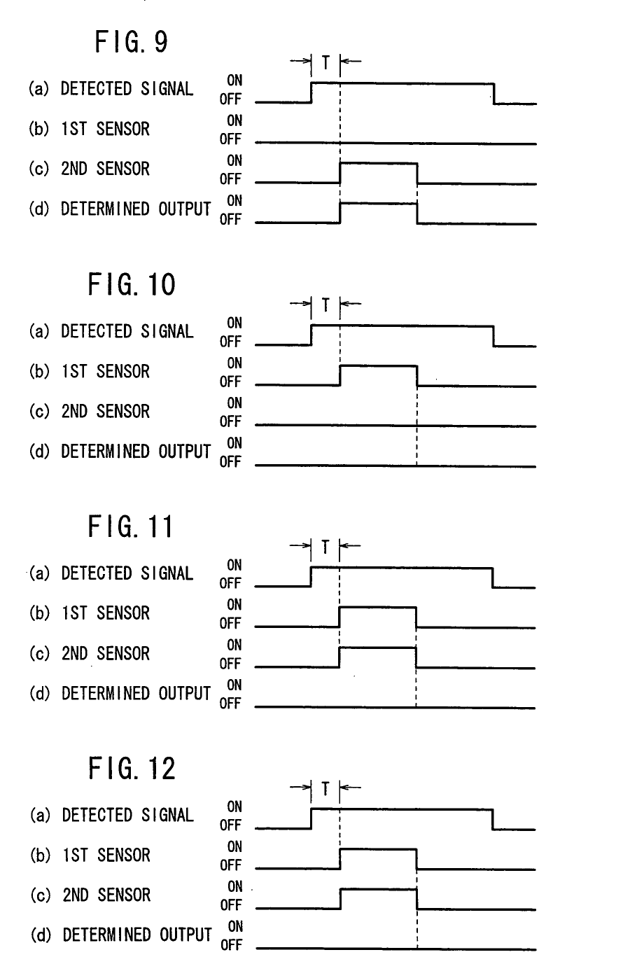

FIGS. 9 through 12 are timing charts, indicating sets of signals that are produced based on positional relationships between the printed state detecting mark 18 on the object 14 and the first and second sensors 26, 28, in which the first and second sensors 26, 28 have respective first and second reading ranges 38, 40 as shown in FIGS. 5 through 8.

FIG. 5 shows a set of signals produced when the first reading range 38 falls within the printed area 34 and the second reading range 40 falls within the non-printed area 36. When the displacement time T set in step S1 has elapsed after detection of the object 14 by the position detector 22, the determining unit 30 compares the first and second detected amounts of light with first and second threshold levels. As shown in FIG. 9, the determining unit 30 produces a first comparison result “OFF” as a result of the comparison between the first detected amount of light and the first threshold level (see (b) in FIG. 9), and produces a second comparison result “ON” as a result of the comparison between the second detected amount of light and the second threshold level (see (c) in FIG. 9). Based on this combination of detected results, the determining unit 30 judges that the printed state on the object 14 is normal, and produces a determined output “ON” (see (d) in FIG. 9).

FIG. 6 shows a set of signals produced when the object 14 is positionally shifted in a direction toward the second reading range 40, which is perpendicular to the direction in which the object 14 is fed. As shown in FIG. 6, the first reading range 38 is displaced from the printed area 34 and the second reading range 40 falls within the printed area 34. In this case, as shown in FIG. 10, the determining unit 30 produces a first comparison result “ON” (see (b) in FIG. 10), and produces a second comparison result “OFF” (see (c) in FIG. 10). Based on this combination of detected results, the determining unit 30 judges that printing on the object 14 is shifted in a direction toward the second reading range (40), which is perpendicular to the direction in which the object 14 is fed, and produces a determined output “OFF” (see (d) in FIG. 10).

FIG. 7 shows a set of signals produced when the object 14 is positionally shifted in a direction toward the first reading range (38), which likewise is perpendicular to the direction in which the object 14 is fed. As shown in FIG. 7, the first reading range 38 and the second reading range 40 are displaced from the printed area 34. In this case, as shown in FIG. 11, the determining unit 30 produces a first comparison result “ON” (see (b) in FIG. 11), and produces a second comparison result “ON” (see (c) in FIG. 11). Based on this combination of detected results, the determining unit 30 judges that printing on the object 14 is shifted in the direction toward the first reading range (38), which is perpendicular to the direction in which the object 14 is fed, and produces a determined output “OFF” (see (d) in FIG. 11).

FIG. 8 shows a set of signals produced when the object 14 is positionally shifted in the direction in which the object 14 is fed. As shown in FIG. 8, the first reading range 38 and the second reading range 40 are both displaced from the printed area 34. In this case, as shown in FIG. 12, the determining unit 30 produces a first comparison result “ON” (see (b) in FIG. 12), and a second comparison result “ON” (see (c) in FIG. 12). Based on this combination of detected results, the determining unit 30 judges that printing on the object 14 is shifted in the direction in which the object 14 is fed, and produces a determined output “OFF” (see (d) in FIG. 12).

Although not shown, if the printed marks 16 on the object 14 are properly positioned, but the distance between the object 14 and nozzle of the printing device, such as an ink-jet printer or the like, is not proper, or if a printing failure occurs due to clogging of the print head nozzle, then since the printed area 34 of the printed state detecting mark 18 varies, the determining unit 30 produces first and second comparison results which are both either “ON” or “OFF”. In this case, the determining unit 30 judges that printing has not been made properly on the object 14, and produces a determined output “OFF”. The determining unit 30 also produces a determined output “OFF” when printed marks 16 are not printed at all on the object 14.

As described above, if the first comparison result is “ON” and the second comparison result is “OFF”, then the determining unit 30 judges that printing on the object 14 is shifted in a direction toward the second reading range (40), which is perpendicular to the direction in which the object 14 is fed.

If the first comparison result is “ON” and the second comparison result is “ON”, then the determining unit 30 judges that printing on the object 14 is shifted in a direction toward the first reading range (38), which is perpendicular to the direction in which the object 14 is fed, or is shifted in a direction in which the object 14 is fed, or that the printing device, such as an ink-jet printer or the like, suffers from a clogged nozzle or an ink shortage.

If the first comparison result is “OFF” and the second comparison result is “ON”, then the determining unit 30 judges that printing on the object 14 is normal.

The determined result, based on the combination of the first comparison result and the second comparison result, is displayed on the display unit 32 in step S7. If a printing failure is judged, then the cause of the printing failure can be identified and displayed on the display unit 32, based on the combination of the first comparison result and the second comparison result. More specifically, the failure can be identified and displayed as a positional shift of the printing in the direction in which the object 14 is fed, a positional shift of the printing in a direction perpendicular to the direction in which the object 14 is fed, a double print blur, no printing, or printing having an incorrect print size.

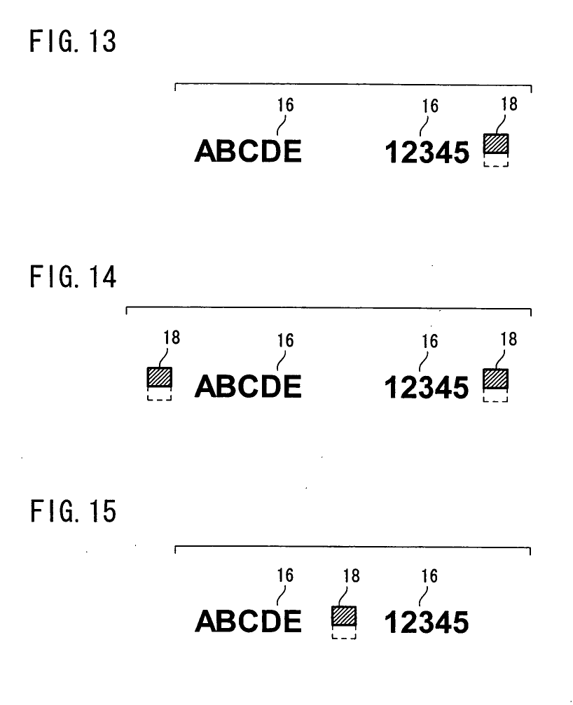

FIGS. 13 through 15 show positional relationships between the printed marks 16 and the printed state detecting mark 18. As shown in FIGS. 13 through 15, the printed state detecting mark 18 may be printed forwardly or rearwardly of the printed marks 16 in the direction in which the printed marks 16 are fed, both forwardly and rearwardly of the printed marks 16 in the direction in which the printed marks 16 are fed, or between one group of printed marks 16 and another group of printed marks 16.

With the printed state detecting apparatus 10, according to the present embodiments described above, the printed state detecting mark 18, which is made up of the printed area 34 and the non-printed area 36, is printed on the object 14 together with the printed marks 16. The printed state detecting mark 18 is detected by the first sensor 26 and the second sensor 28, and based on the detected results from the first sensor 26 and the second sensor 28, the determining unit 30 determines a printed state, including for example a positional shift, on the object 14.

In the illustrated embodiment, when the displacement time T has elapsed in step S4 after the detected signal from the position detector 22, representing detection of the object 14, has been input to the determining unit 30, the first sensor 26 and the second sensor 28 detect the printed state detecting mark 18 in step S5, and then the determining unit 30 determines the printed state on the object 14 in step S6.

However, when the position detector 22 detects the object 14, the detected signal from the position detector 22 may be continuously kept in an ON state during which time the determining unit 30 may determine a printed state, and in this case, if the first sensor 26 or the second sensor 28 detects one of the printed marks 16 or the printed state detecting mark 18 while the detected signal from the position detector 22 is in an OFF state, the determining unit 30 can judge that the marks are printed twice. Furthermore, the displacement time T may be set to T=0 and the determining unit 30 may start determining a printed state at the same time that the detected signal is supplied. Further, although in the above embodiments the marks are printed on the object using a black ink, any object 14 and any printing device may be combined, so long as the difference between the detected amount of light from the printed area 34 and the detected amount of light from the non-printed area 36 can be distinguished from each other.

Although certain preferred embodiments of the present invention have been shown and described in detail, it should be understood that various changes and modifications may be made therein without departing from the scope of the invention as set forth in the appended claims.

1. An apparatus for detecting a printed state, comprising:
a first sensor for detecting light from a printed area of a printed state detecting mark printed on an object, said printed state detecting mark comprising said printed area and a non-printed area;
a second sensor for detecting light from said non-printed area; and
a determining unit for comparing a first detected amount of light detected by said first sensor with a predetermined first threshold level to produce a first comparison result, comparing a second detected amount of light detected by said second sensor with a predetermined second threshold level to produce a second comparison result, and determining a printed state of a printed mark on the object based on said first comparison result and said second comparison result.

2. An apparatus according to claim 1, further comprising:
an illuminating unit for illuminating said printed state detecting mark.

3. An apparatus according to claim 1, wherein said printed area comprises a black printed area; and
said determining unit judges a printing failure if said first detected amount of light is greater than said first threshold level or said second detected amount of light is smaller than said second threshold level.

4. An apparatus according to claim 1, further comprising:
a detector for detecting the object as the object is fed;
wherein said first sensor and said second sensor detect said printed state detecting mark at a predetermined time after said detector detects the object.

5. An apparatus according to claim 1, wherein said printed mark and said printed state detecting mark are printed on the object by a single printing means.

6. An apparatus according to claim 1, wherein each of said first sensor and said second sensor comprises a reflective sensor for detecting light reflected from the object.

7. An apparatus according to claim 1, wherein each of said first sensor and said second sensor comprises a transmissive sensor for detecting light transmitted through the object.

8. An apparatus according to claim 1, wherein said printed state detecting mark is different in shape from said printed mark.

9. An apparatus according to claim 1, wherein said first sensor has a first reading range and said second sensor has a second reading range, said first reading range and said second reading range being equal to or smaller than said printed area and said non-printed area.

10. An apparatus according to claim 1, further comprising:
a display unit for displaying the printed state determined by said determining unit.

11. A method of detecting a printed state, comprising the steps of:
printing a printed state detecting mark on an object, said printed state detecting mark having a printed area and a non-printed area;
detecting light from said printed area with a first sensor and light from said non-printed area with a second sensor;
comparing a first detected amount of light detected by said first sensor with a predetermined first threshold level to produce a first comparison result;
comparing a second detected amount of light detected by said second sensor with a predetermined second threshold level to produce a second comparison result; and
determining a printed state of a printed mark on the object based on said first comparison result and said second comparison result.

12. A method according to claim 11, further comprising the steps of:
feeding the object with said printed state detecting mark printed thereon; and
detecting the object as the object is fed,
wherein said first sensor and said second sensor detect said printed state detecting mark at a time related to the time when the object is detected.
